(19) United States
(12) Patent Application Publication
(10) Pub. No.: US 2024/0063394 A1
(43) Pub. Date: Feb. 22, 2024

(54) CRYSTALLINE MATERIAL ADDITIVES FOR THICK ELECTRODES

(71) Applicant: GM GLOBAL TECHNOLOGY OPERATIONS LLC, (US)

(72) Inventors: Yong LU, Shanghai (CN); Si CHEN, Shanghai (CN); Haijing LIU, Shanghai (CN)

(73) Assignee: GM GLOBAL TECHNOLOGY OPERATIONS LLC, Detroit, MI (US)

(21) Appl. No.: 18/070,058

(22) Filed: Nov. 28, 2022

(30) Foreign Application Priority Data
Aug. 16, 2022 (CN) 202210980873.8

(51) Int. Cl. H01M 4/62; H01M 10/0525; H01M 50/46

(52) U.S. Cl. CPC H01M 4/624; H01M 10/0525; H01M 4/623; H01M 50/46; H01M 2004/021

(57) ABSTRACT

The present disclosure provides an electrode for use in an electrochemical cell that cycles lithium ions. The electrode has a thickness greater than or equal to about 50 micrometers to less than or equal to about 500 micrometers and includes an electroactive material, a polytetrafluoroethylene-based binder, and a porous crystalline material additive. For example, the electrode may include greater than or equal to about 0.01 wt. % to less than or equal to about 20 wt. % of the porous crystalline material additive, and greater than or equal to about 0.01 wt. % to less than or equal to about 20 wt. % of the polytetrafluoroethylene-based binder. The porous crystalline material additive is selected from the group consisting of: metal-organic frameworks (MOFs), covalent-organic frameworks (COFs), and combinations thereof.

### CROSS-REFERENCE TO RELATED APPLICATIONS

This application claims the benefit and priority of Chinese Application No. 202210980873.8, filed Aug. 16, 2022. The entire disclosure of the above application is incorporated herein by reference.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator filled with a liquid or solid electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte (or solid-state separator), the solid-state electrolyte (or solid-state separator) may physically separate the electrodes so that a distinct separator is not required.

Many different materials may be used to create components for a lithium-ion battery. For example, the use of polytetrafluoroethylene (PTFE) as an electrode binder is often desirable because the binder holds extra active materials permitting thicker electrodes, resulting in higher energy density of battery, while also exhibiting higher temperature tolerance (e.g., greater than or equal to about 150° C., up to 327° C.). However, polytetrafluoroethylene (PTFE) has poor wettability with liquid electrolytes, negatively influencing rate performance and fast charging capabilities of the battery. It would be desirable to develop improved electrode materials, and methods of making and using the same, that can address these challenges.

### SUMMARY

This section provides a general summary of the disclosure, and is not a comprehensive disclosure of its full scope or all of its features.

The present disclosure relates to porous crystalline material additives for electrochemical cells that cycle lithium ions, and to methods of making and using the same. The porous crystalline material additives may be included in one or both of the positive and negative electrodes defining the cell.

In various aspects, the present disclosure provides an electrode for use in an electrochemical cell that cycles lithium ions. The electrode includes an electroactive material, a polytetrafluoroethylene-based binder, and a porous crystalline material additive. The porous crystalline material additive may be selected from the group consisting of: metal-organic frameworks (MOFs), covalent-organic frameworks (COFs), and combinations thereof.

In one aspect, the electrode includes greater than or equal to about 0.01 wt. % to less than or equal to about 20 wt. % of the porous crystalline material additive.

In one aspect, the metal-organic frameworks (MOFs) may have a surface area greater than or equal to about 1,000 m²/g and may be selected from the group consisting of: IRMOF-16 (Zn₄O(TPDC)₃), IRMOF-1 (Zn₄O(BDC)₃), IRMOF-2 (Zn₄O(BDC-NH₂)₃), IRMOF-8, IRMOF-10, IRMOF-12, IRMOF-14, IRMOF-15, MOF-177 (C₅₄H₁₅O₁₃Zn₄), MOF-188, MOF-200 (Zn₄O(BBC)₂), IRMOF-74-I (Mg₂(DOT)), IRMOF-74-II (Mg2(DH2PHDC)), IRMOF-74-III (Mg₂(DH3PhDC)), HKUST-1 ([Cu₃(C₉H₃O₆)₂]ₙ), MIL-53 (Fe(OH(BDC)), MIL-100 (Fe₃F(H₂O)₂O[(C₆H₃)—(CO₂)₃]₂·nH₂O (where 1<n<10)), MIL-101 ([Cr₃OX (bdc)₃(H₂O)₂] (where bdc is benzene-1,4,dicarboxylate and X is OH or F), UIO-66 (Zr₂₄O₁₂₀C₁₉₂H₉₆N₂₄), UIO-67 (Zr₆O₄(OH)₄⁻·(bpdc) (where bpdc is biphenyldicarboxylate (O₂C(C₆H₄)₂CO₂)), UIO-68 (Zr₆O₄(OH)₄(C₂₀H₁₀O₆)₆(C₃H₇NO)(CH₂Cl₂)₃), ZIF-2, ZIF-3, ZIF-4, ZIR-6, ZIF-5 (Zn₃In₂(Im)₁₂), ZIF-11, ZIR-7, ZIR-8 (C₈H₁₀N₄Zn), ZIF-9 (C₇H₆N₂·Co·H₂O), ZIF-11 (Zn[C₇H₅N₂]₂), ZIF-14 (Zn(elm)₂), ZIF-67 (C₈H₁₀N₄Co), ZIF-68 (C_{7.06}H_{4.94}N_{3.53}O_{1.59}Zn_{0.71}), ZIF-90 (C₄₈H₃₆N₂₄O₁₂Zn₆)), CPL-1 ([Cu₂(pzdc)₂(L)]ₙ) (where 1<n<100)), CPL-2 (C₂₂H₁₂N₆O₈Cu₂), CPL-5 (C₂₄H₁₄N₆O₈Cu), and CD-MOFs, PCN-14 (C₂₇₀H₁₆₂Cu₁₈O₉₀), and combinations thereof.

In one aspect, the covalent-organic frameworks (COFs) may have a surface area greater than or equal to about 1,000 m²/g and may be selected from the group consisting of: COF-1, COF-103, HHTP-DPB COF, COF-300, COF-LZU1, COF-320, BF-COF-1, BF-COF-2, LZU-301, COF-42, COF-43, COF-JLU4, TFTP-COF, LZU-21, Py-Azine COF, HEX-COF-1, ACOF, PI-COF-1, PI-COF-2, COF-77, COF-78, TFP-TPP CH2OF, TFP-TPA COF, TFP-Car COF, β-ketoenamine-linked COFs, sp²c-COF, sp²c-COF-2, sp²c-COF-3, COF-202, polyarylether-based COFs (PAE-COFs), triazine-based COFS, HHTP-FPBA-TATTA COF, and combinations thereof.

In one aspect, the electrode may include greater than or equal to about 0.01 wt. % to less than or equal to about 20 wt. % of the polytetrafluoroethylene-based binder.

In one aspect, the polytetrafluoroethylene-based binder may include greater than or equal to about 50 wt. % to less than or equal to about 100 wt. % of polytetrafluoroethylene (PTFE), and greater than 0 wt. % to less than or equal to about 50 wt. % of an additional binder.

In one aspect, the additional binder may be selected from the group consisting of: sodium carboxymethyl cellulose (CMC), polyvinylidene difluoride (PVdF), polyethylene oxide (PEO), polyethylene (PE), polypropylene (PP), and combinations thereof.

In one aspect, the electrode may further include greater than 0 wt. % to less than or equal to about 30 wt. % of an electrically conductive material.

In one aspect, the electrode may have an average thickness greater than or equal to about 50 micrometers to less than or equal to about 500 micrometers.

In various aspects, the present disclosure provides an electrochemical cell that cycles lithium ions. the electrochemical cell may include a first electrode, a second electrode, and a separating layer disposed between the first electrode and the second electrode. The first electrode may include a first electroactive material, a polytetrafluoroethylene-based binder, and a porous crystalline material additive. The porous crystalline material additive may be selected from the group consisting of: metal-organic frameworks (MOFs), covalent-organic frameworks (COFs), and combinations thereof.

In one aspect, the first electrode may include greater than or equal to about 0.01 wt. % to less than or equal to about 20 wt. % of the porous crystalline material additive, and greater than or equal to about 0.01 wt. % to less than or equal to about 20 wt. % of the polytetrafluoroethylene-based binder.

In one aspect, the polytetrafluoroethylene-based binder may include greater than or equal to about 50 wt. % to less than or equal to about 100 wt. % of polytetrafluoroethylene (PTFE), and greater than 0 wt. % to less than or equal to about 50 wt. % of an additional binder. The additional binder may be selected from the group consisting of: sodium carboxymethyl cellulose (CMC), polyvinylidene difluoride (PVdF), polyethylene oxide (PEO), polyethylene (PE), polypropylene (PP), and combinations thereof.

In one aspect, the metal-organic frameworks (MOFs) may have a surface area greater than or equal to about 1,000 m²/g and may be selected from the group consisting of: IRMOF-16 (Zn₄O(TPDC)₃), IRMOF-1 (Zn₄O(BDC)₃), IRMOF-2 (Zn₄O(BDC-NH₂)₃), IRMOF-8, IRMOF-10, IRMOF-12, IRMOF-14, IRMOF-15, MOF-177 (C₅₄H₁₅O₁₃Zn₄), MOF-188, MOF-200 (Zn₄O(BBC)₂), IRMOF-74-I (Mg₂(DOT)), IRMOF-74-II (Mg2(DH2PHDC)), IRMOF-74-III (Mg₂(DH3PhDC)), HKUST-1 ([Cu₃(C₉H₃O₆)₂]ₙ), MIL-53 (Fe(OH(BDC)), MIL-100 (Fe₃F(H₂O)₂O[(C₆H₃)—(CO₂)₃]₂·nH₂O (where 1<n<10)), MIL-101 ([Cr₃OX (bdc)₃(H₂O)₂] (where bdc is benzene-1,4,dicarboxylate and X is OH or F), UIO-66 (Zr₂₄O₁₂₀C₁₉₂H₉₆N₂₄), UIO-67 (Zr₆O₄(OH)₄⁻·(bpdc) (where bpdc is biphenyldicarboxylate (O₂C(C₆H₄)₂CO₂)), UIO-68 (Zr₆O₄(OH)₄(C₂₀H₁₀O₆)₆(C₃H₇NO)(CH₂Cl₂)₃), ZIF-2, ZIF-3, ZIF-4, ZIR-6, ZIF-5 (Zn₃In₂(Im)₁₂), ZIF-11, ZIR-7, ZIR-8 (C₈H₁₀N₄Zn), ZIF-9 (C₇H₆N₂·Co·H₂O), ZIF-11 (Zn[C₇H₅N₂]₂), ZIF-14 (Zn(elm)₂), ZIF-67 (C₈H₁₀N₄Co), ZIF-68 (C_{7.06}H_{4.94}N_{3.53}O_{1.59}Zn_{0.71}), ZIF-90 (C₄₈H₃₆N₂₄O₁₂Zn₆)), CPL-1 ([Cu₂(pzdc)₂(L)]ₙ) (where 1<n<100)), CPL-2 (C₂₂H₁₂N₆O₈Cu₂), CPL-5 (C₂₄H₁₄N₆O₈Cu), and CD-MOFs, PCN-14 (C₂₇₀H₁₆₂Cu₁₈O₉₀), and combinations thereof; and the covalent-organic frameworks (COFs) may have a surface area greater than or equal to about 1,000 m²/g and may be selected from the group consisting of: COF-1, COF-103, HHTP-DPB COF, COF-300, COF-LZU1, COF-320, BF-COF-1, BF-COF-2, LZU-301, COF-42, COF-43, COF-JLU4, TFTP-COF, LZU-21, Py-Azine COF, HEX-COF-1, ACOF, PI-COF-1, PI-COF-2, COF-77, COF-78, TFP-TPP CH2OF, TFP-TPA COF, TFP-Car COF, β-ketoenamine-linked COFs, sp²c-COF, sp²c-COF-2, sp²c-COF-3, COF-202, polyarylether-based COFs (PAE-COFs), triazine-based COFS, HHTP-FPBA-TATTA COF, and combinations thereof.

In one aspect, the electrode may further include greater than 0 wt. % to less than or equal to about 30 wt. % of an electrically conductive material.

In one aspect, the electrode may have an average thickness greater than or equal to about 50 micrometers to less than or equal to about 500 micrometers.

In one aspect, the polytetrafluoroethylene-based binder may be a first polytetrafluoroethylene-based binder, the porous crystalline material additive may be a first porous crystalline material additive, and the second electrode may further include a second polytetrafluoroethylene-based binder and a second porous crystalline material additive. The second porous crystalline material additive may be selected from the group consisting of: metal-organic frameworks (MOFs), covalent-organic frameworks (COFs), and combinations thereof. The second polytetrafluoroethylene-based binder may be the same as or different from the first polytetrafluoroethylene-based binder, and the second porous crystalline material additive may be the same as or different from the first porous crystalline material additive.

In one aspect, the second electrode may include greater than or equal to about 0.01 wt. % to less than or equal to about 20 wt. % of the porous crystalline material additive, and greater than or equal to about 0.01 wt. % to less than or equal to about 20 wt. % of the polytetrafluoroethylene-based binder.

In various aspects, the present disclosure provides an electrochemical cell that cycles lithium ions. The electrochemical cell may include a first electrode, a second electrode, and a separating layer disposed between the first electrode and the second electrode. The first electrode may have a first average thickness greater than or equal to about 50 micrometers to less than or equal to about 500 micrometers. The first electrode may include greater than 0 wt. % to less than or equal to about 99.5 wt. % of a first electroactive material, greater than 0.01 wt. % to less than or equal to about 20 wt. % of a first polytetrafluoroethylene-based binder, and greater than 0.01 wt. % to less than or equal to about 20 wt. % of a first porous crystalline material additive. The second electrode may have a second average thickness greater than or equal to about 50 micrometers to less than or equal to about 500 micrometers. The second electrode may include greater than 0 wt. % to less than or equal to about 99.5 wt. % of a second electroactive material, greater than 0.01 wt. % to less than or equal to about 20 wt. % of a second polytetrafluoroethylene-based binder, and greater than 0.01 wt. % to less than or equal to about 20 wt. % of a second porous crystalline material additive. The first and second crystalline material additives may be independently selected from the group consisting of: metal-organic frameworks (MOFs), covalent-organic frameworks (COFs), and combinations thereof.

In one aspect, at least one of the first electrode and the second electrode may further include greater than 0 wt. % to less than or equal to about 30 wt. % of an electrically conductive material.

In one aspect, the metal-organic frameworks (MOFs) may have a surface area greater than or equal to about 1,000 m²/g and may be selected from the group consisting of: IRMOF-16 (Zn₄O(TPDC)₃), IRMOF-1 (Zn₄O(BDC)₃), IRMOF-2 (Zn₄O(BDC-NH₂)₃), IRMOF-8, IRMOF-10, IRMOF-12, IRMOF-14, IRMOF-15, MOF-177 (C₅₄H₁₅O₁₃Zn₄), MOF-188, MOF-200 (Zn₄O(BBC)₂), IRMOF-74-I (Mg₂(DOT)), IRMOF-74-II (Mg2(DH2PHDC)), IRMOF-74-III (Mg₂(DH3PhDC)), HKUST-1 ([Cu₃(C₉H₃O₆)₂]ₙ), MIL-53 (Fe(OH(BDC)), MIL-100 (Fe₃F(H₂O)₂O[(C₆H₃)—(CO₂)₃]₂·nH₂O (where 1<n<10)), MIL-101 ([Cr₃OX (bdc)₃(H₂O)₂] (where bdc is benzene-1,4,dicarboxylate and X is OH or F), UIO-66 (Zr₂₄O₁₂₀C₁₉₂H₉₆N₂₄), UIO-67 (Zr₆O₄(OH)₄⁻·(bpdc) (where bpdc is biphenyldicarboxylate (O₂C(C₆H₄)₂CO₂)), UIO-68 (Zr₆O₄(OH)₄(C₂₀H₁₀O₆)₆(C₃H₇NO)(CH₂Cl₂)₃), ZIF-2, ZIF-3, ZIF-4, ZIR-6, ZIF-5 (Zn₃In₂(Im)₁₂), ZIF-11, ZIR-7, ZIR-8 (C₈H₁₀N₄Zn), ZIF-9 (C₇H₆N₂·Co·H₂O), ZIF-11 (Zn[C₇H₅N₂]₂), ZIF-14 (Zn(elm)₂), ZIF-67 (C₈H₁₀N₄Co), ZIF-68 (C_{7.06}H_{4.94}N_{3.53}O_{1.59}Zn_{0.71}), ZIF-90 (C₄₈H₃₆N₂₄O₁₂Zn₆)), CPL-1 ([Cu₂(pzdc)₂(L)]ₙ) (where 1<n<100)), CPL-2 (C₂₂H₁₂N₆O₈Cu₂), CPL-5 (C₂₄H₁₄N₆O₈Cu), and CD-MOFs, PCN-14 (C₂₇₀H₁₆₂Cu₁₈O₉₀), and combinations thereof; and the covalent-organic frameworks (COFs) may have a surface area greater than or equal to about 1,000 m²/g and may be selected from the group consisting of: COF-1, COF-103, HHTP-DPB COF, COF-300, COF-LZU1, COF-320, BF-COF-1, BF-COF-2, LZU-301, COF-42, COF-43, COF-JLU4, TFTP-COF, LZU-21, Py-Azine COF, HEX-COF-1, ACOF, PI-COF-1, PI-COF-2, COF-77, COF-78, TFP-TPP CH2OF, TFP-TPA COF, TFP-Car COF, β-ketoenamine-linked COFs, sp²c-COF, sp²c-COF-2, sp²c-COF-3, COF-202, polyarylether-based COFs (PAE-COFs), triazine-based COFS, HHTP-FPBA-TATTA COF, and combinations thereof.

Corresponding reference numerals indicate corresponding parts throughout the several views of the drawings.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic of an example electrochemical cell unit where one or both of the positive and negative electrodes includes a porous crystalline material additive in accordance with various aspects of the present disclosure;

FIG. 2 is a flowchart illustrating an example method for forming an electrode including a porous crystalline material additive in accordance with various aspects of the present disclosure;

FIG. 3 is a flowchart illustrating another example method for forming an electrode including a porous crystalline material additive in accordance with various aspects of the present disclosure;

FIG. 4A is a graphical illustration demonstrating the discharge rate for a cell including an electrode having a porous crystalline material additive in accordance with various aspects of the present disclosure; and

FIG. 4B is a graphical illustration demonstrating the 2C charge for a cell including an electrode having a porous crystalline material additive in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology relates to porous crystalline material additives for electrochemical cells that cycle lithium ions, and to methods of making and using the same. The porous crystalline material additives may be included in one or both of the positive and negative electrodes defining the cell. Such cells can be used in vehicle or automotive transportation applications (e.g., motorcycles, boats, tractors, buses, motorcycles, mobile homes, campers, and tanks). However, the present technology may also be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples detail below include a single positive electrode cathode and a single anode, the skilled artisan will recognize that the present teachings also extend to various other configurations, including those having one or more cathodes and one or more anodes, as well as various current collectors with electroactive layers disposed on or adjacent to one or more surfaces thereof.

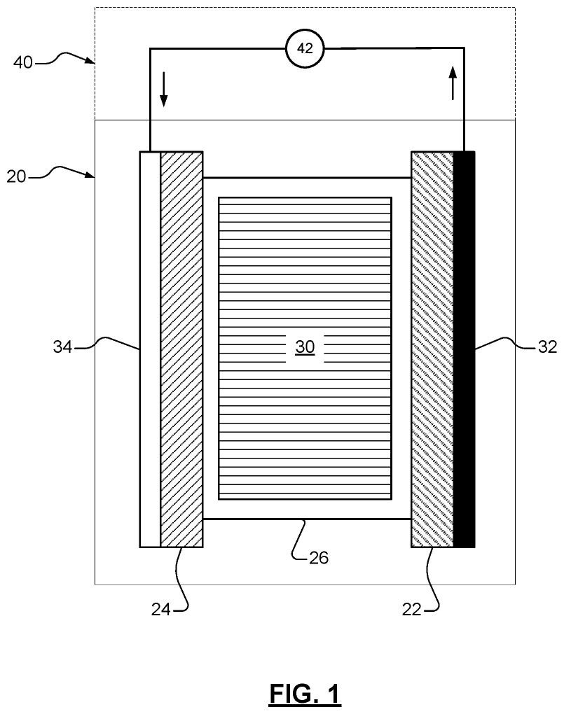

An exemplary and schematic illustration of an electrochemical cell (also referred to as a battery) 20 is shown in FIG. 1. The battery 20 includes a negative electrode 22 (e.g., anode), a positive electrode 24 (e.g., cathode), and a separator 26 disposed between the two electrodes 22, 24. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and/or the positive electrode 24, so as to form a continuous electrolyte network. In certain variations, the separator 26 may be formed by a solid-state electrolyte or a semi-solid-state electrolyte (e.g., gel electrolyte). For example, the separator 26 may be defined by a plurality of solid-state electrolyte particles. In the instance of solid-state batteries and/or semi-solid-state batteries, the positive electrode 24 and/or the negative electrode 22 may include a plurality of solid-state electrolyte particles. The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode 22. The first current collector 32 together with the negative electrode 22 may be referred to as a negative electrode assembly. Although not illustrated, the skilled artisan will appreciate that, in certain variations, negative electrodes 22 (also referred to as negative electroactive material layers) may be disposed on one or more parallel sides of the first current collector 32. Similarly, the skilled artisan will appreciate that, in other variations, a negative electroactive material layer may be disposed on a first side of the first current collector 32, and a positive electroactive material layer may be disposed on a second side of the first current collector 32. In each instance, the first current collector 32 may include a metal foil, metal grid or screen, expanded metal comprising copper, or any other appropriate electrically conductive material known to those of skill in the art.

A second current collector 34 (e.g., a positive current collector) may be positioned at or near the positive electrode 24. The second current collector 34 together with the positive electrode 24 may be referred to as a positive electrode assembly. Although not illustrated, the skilled artisan will appreciate that, in certain variations, positive electrodes 24 (also referred to as positive electroactive material layers) may be disposed on one or more parallel sides of the second current collector 34. Similarly, the skilled artisan will appreciate that, in other variations, a positive electroactive material layer may be disposed on a first side of the second current collector 34, and a negative electroactive material layer may be disposed on a second side of the second current collector 34. In each instance, the second electrode current collector 34 may include a metal foil, metal grid or screen, expanded metal comprising aluminum, or any other appropriate electrically conductive material known to those of skill in the art.

The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34). The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

The size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. For example, in certain aspects, the electrolyte 30 may be a non-aqueous liquid electrolyte solution (e.g., >1 M) that includes a lithium salt dissolved in an organic solvent or a mixture of organic solvents. Numerous conventional non-aqueous liquid electrolyte 30 solutions may be employed in the battery 20.

A non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof. These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC), vinylene carbonate (VC), and the like), linear carbonates (e.g., dimethyl carbonate (DMC), diethyl carbonate (DEC), ethylmethylcarbonate (EMC), and the like), aliphatic carboxylic esters (e.g., methyl formate, methyl acetate, methyl propionate, and the like), γ-lactones (e.g., γ-butyrolactone, γ-valerolactone, and the like), chain structure ethers (e.g., 1,2-dimethoxyethane, 1-2-diethoxyethane, ethoxymethoxyethane, and the like), cyclic ethers (e.g., tetrahydrofuran, 2-methyltetrahydrofuran, 1,3-dioxolane, and the like), sulfur compounds (e.g., sulfolane), and combinations thereof.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be admixed with the ceramic material and/or the heat-resistant material, or one or more surfaces of the separator 26 may be coated with the ceramic material and/or the heat-resistant material. In certain variations, the ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: Nomex, Aramid, and combinations thereof.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about 1 micrometer (μm) to less than or equal to about 50 μm, and in certain instances, optionally greater than or equal to about 1 μm to less than or equal to about 20 μm.

In various aspects, the porous separator 26 and/or the electrolyte 30 disposed in the porous separator 26 as illustrated in FIG. 1 may be replaced with a solid-state electrolyte (“SSE”) and/or semi-solid-state electrolyte (e.g., gel) that functions as both an electrolyte and a separator. For example, the solid-state electrolyte and/or semi-solid-state electrolyte may be disposed between the positive electrode 24 and negative electrode 22. The solid-state electrolyte and/or semi-solid-state electrolyte facilitates transfer of lithium ions, while mechanically separating and providing electrical insulation between the negative and positive electrodes 22, 24. By way of non-limiting example, the solid-state electrolyte and/or semi-solid-state electrolyte may include a plurality of fillers, such as LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99} Ba_{0.005}ClO, or combinations thereof. The semi-solid-state electrolyte may include a polymer host and a liquid electrolyte. The polymer host may include, for example, polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. In certain variations, the semi-solid or gel electrolyte may also be found in the positive electrode 24 and/or the negative electrodes 22.

The negative electrode 22 is formed from a lithium host material that is capable of functioning as a negative terminal of a lithium-ion battery. In various aspects, the negative electrode 22 may be defined by a plurality of negative electroactive material particles. Such negative electroactive material particles may be disposed in one or more layers so as to define the three-dimensional structure of the negative electrode 22. The electrolyte 30 may be introduced, for example after cell assembly, and contained within pores of the negative electrode 22 between the negative electroactive material particles. For example, in certain variations, the negative electrode 22 may include a plurality of solid-state electrolyte particles dispersed with the negative electroactive material particles. In each instance, the negative electrode 22 (including the one or more layers) may have an average thickness greater than or equal to about 1 μm to less than or equal to about 1,000 μm, and in certain aspects, optionally greater than or equal to about 10 μm to less than or equal to about 200 μm.

In various aspects, negative electrode 22 may include a lithium-containing negative electroactive material, such as a lithium alloy and/or a lithium metal. For example, in certain variations, the negative electrode 22 may be defined by a lithium metal foil. In other variations, the negative electrode 22 may include, for example only, carbonaceous materials (such as, graphite, hard carbon, soft carbon, and the like) and/or metallic active materials (such as tin, aluminum, magnesium, germanium, and alloys thereof, and the like) and/or metal oxides (such as SnO₂, Fe₃O₄, and the like). In further variations, the negative electrode 22 may include a silicon-based electroactive material (such as silicon (Si), silicon oxide (SiOₓ, 0≤x≤2), and the like).

In still further variations, the negative electrode 22 may be a composite electrode including a combination of negative electroactive materials. For example, the negative electrode 22 may include a first negative electroactive material and a second negative electroactive material. In certain variations, a mass ratio of the first negative electroactive material to the second negative electroactive material may be greater than or equal to about 5:95 to less than or equal to about 95:5. The first negative electroactive material may be a volume-expanding material including, for example, silicon, aluminum, germanium, and/or tin. The second negative electroactive material may include a carbonaceous material (e.g., graphite, hard carbon, and/or soft carbon) For example, in certain variations, the negative electroactive material may include a carbonaceous-silicon based composite including, for example, about 10 wt. % SiOₓ (where 0≤x≤2) and about 90 wt. % graphite. In each instance, the negative electroactive material may be prelithiated.

In certain variations, the negative electroactive material may be optionally intermingled (e.g., slurry casted) with an electronically conductive material (i.e. conductive additive) that provide an electron conductive path and/or a polymeric binder material that improve the structural integrity of the negative electrode 22. For example, the negative electrode 22 may include greater than or equal to about 0 wt. % to less than or equal to about 99.5 wt. %, and in certain aspects, optionally greater than or equal to about 60 wt. % to less than or equal to about 95 wt. %, of the negative electroactive material; greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, optionally greater than or equal to about 0.01 wt. % to less than or equal to about 20 wt. %, and in certain aspects, optionally greater than or equal to about 0.01 wt. % to less than or equal to about 5 wt. %, of the polymeric binder.

Electronically conducting materials may include, for example, carbon-based materials, powdered nickel or other metal particles, or conductive polymers. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples conductive polymers include polyaniline (PANi), polythiophene, polyacetylene, polypyrrole (PPy), and the like.

Example polymeric binders include, for example, polyimide, polyamic acid, polyamide, polysulfone, polyvinylidene difluoride (PVdF), polytetrafluoroethylene (PTFE), polyacrylic acid (PAA), blends of polyvinylidene fluoride and polyhexafluoropropene, polychlorotrifluoroethylene, ethylene propylene diene monomer (EPDM) rubber, carboxymethyl cellulose (CMC), nitrile butadiene rubber (NBR), styrene-butadiene rubber (SBR), lithium polyacrylate (LiPAA), sodium polyacrylate (NaPAA), styrene ethylene butylene styrene copolymer (SEBS), styrene butadiene styrene copolymer (SBS), polyethylene oxide (PEO), polyethylene (PE), polypropylene (PP), sodium alginate, and/or lithium alginate. In certain variations, the negative electrode 22 may include a combination of binders. For example, the negative electrode 22 may include greater than or equal to about 50 wt. % to less than or equal to about 100 wt. %, and in certain aspects, optionally greater than or equal to about 70 wt. % to less than or equal to about 90 wt. %, of a first binder, and greater than or equal to about 0 wt. % to less than or equal to about 50 wt. %, and in certain aspects, optionally greater than or equal to about 10 wt. % to less than or equal to about 30 wt. %, of a second binder. The first binder may include polytetrafluoroethylene (PTFE), and the second binder may include, for example, sodium carboxymethyl cellulose (CMC), polyvinylidene difluoride (PVdF), polyethylene oxide (PEO), polyethylene (PE), and/or polypropylene (PP). In such instances, the composite may be referred to as a polytetrafluoroethylene-based binder.

In certain variations, for example, when the negative electrode 22 includes polytetrafluoroethylene (PTFE) and/or polytetrafluoroethylene-based binders, the negative electrode 22 may optionally include porous crystalline material additives, such as metal-organic frameworks (MOFs) and/or covalent-organic frameworks (COFs), each having ordered 1D to 3D pore structures, resulting in ultra-high specific surface areas (e.g., up to 10,500 m²/g). For example, the negative electrode 22 may include greater than or equal to about 0 wt. % to less than or equal to about 20 wt. %, optionally greater than or equal to about 0.01 wt. % to less than or equal to about 20 wt. %, and in certain aspects, optionally greater than or equal to about 0.01 wt. % to less than or equal to about 5 wt. %, of the porous crystalline material additive, and a ratio of the porous crystalline material additive to the polytetrafluoroethylene (PTFE)-based binder may be greater than or equal to about 0.5 to less than or equal to about 2, and in certain aspects, optionally greater than or equal to about 0.6 to less than or equal to about 1. The porous crystalline material additives (i.e., the metal-organic frameworks (MOFs) and/or covalent-organic frameworks (COFs)) may enhance fibrillation within the negative electrode 22, so as to improve the mechanical strength, and enhance the wettability between the polytetrafluoroethylene (PTFE) and the electrolyte. For example, the high specific area of the metal-organic frameworks (MOFs) and/or covalent-organic frameworks (COFs) can be used to provide more anchoring sites for the fibrillation of polytetrafluoroethylene (PTFE), while the nano-size tunable pores of the metal-organic frameworks (MOFs) and/or covalent-organic frameworks (COFs) standing near the polytetrafluoroethylene (PTFE) fibrils are capable of storing more liquid electrolyte (e.g., electrolyte 30).

Example metal-organic frameworks (MOFs) have surface areas greater than or equal to about 1,000 m²/g, and in certain aspects, optionally greater than about 2,000 m²/g, and may include (a) carboxylic acid ligands including, for example, IR-MOF (such as IRMOF-16 (Zn₄O(TPDC)₃), IRMOF-1 (Zn₄O(BDC)₃), IRMOF-2 (Zn₄O(BDC-NH₂)₃), IRMOF-8, IRMOF-10, IRMOF-12, IRMOF-14, IRMOF-15, MOF-177 (C₅₄H₁₅O₁₃Zn₄), MOF-188, MOF-200 (Zn₄O(BBC)₂), IRMOF-74-I (Mg₂(DOT)), IRMOF-74-II (Mg2(DH2PHDC)), and/or IRMOF-74-III (Mg₂(DH3PhDC))), HKUST (such as HKUST-1 ([Cu₃(C₉H₃O₆)₂]h)), MIL (such as MIL-53 (Fe(OH(BDC)), MIL-100 (Fe₃F(H₂O)₂O[(C₆H₃)—(CO₂)₃]₂·nH₂O), and/or MIL-101 ([Cr₃(O)ₓ(bdc)₃(H₂O)₂], where bdc is benzene-1,4,dicarboxylate and X is OH or F)), and/or UiO with Zr₆O₄(OH)₄ (such as UIO-66 (Zr₂₄O₁₂₀C₁₉₂H₉₆N₂₄), UIO-67 (Zr₆O₄(OH)₄⁻·(bpdc), where bpdc is biphenyldicarboxylate (O₂C(C₆H₄)₂CO₂)), and/or UIO-68 (Zr₆O₄(OH)₄(C₂₀H₁₀O₆)₆(C₃H₇NO)(CH₂Cl₂)₃)); (b) heterocyclic ligands containing nitrogen including, for example, ZiF (such as ZIF-2 and ZIF-3 (Zn₂(Im)₄), ZIF-4 and ZIR-6 (Zn(IM₂)), ZIF-5 (Zn₃In₂(Im)₁₂), ZIF-11 and ZIR-7 (Zn(blm)₂, C₇H₆N₂·Zn—H₂O), ZIR-8 (C₈H₁₀N₄Zn), ZIF-9 (C₇H₆N₂·Co·H₂O), ZIF-11 (Zn[C₇H₅N₂]₂), ZIF-14 (Zn(elm)₂), ZIF-67 (C₈H₁₀N₄Co), ZIF-68 (C_{7.06}H_{4.94}N_{3.53}O_{1.59}Zn_{0.71}), and/or ZIF-90 (C₄₈H₃₆N₂₄O₁₂Zn₆)) and/or CPL (such as CPL-1 ([Cu₂(pzdc)₂(L)]ₙ, C₁₆H₈N₆O₈Cu₂), CPL-2 (C₂₂H₁₂N₆O₈Cu₂), and/or CPL-5 (C₂₄H₁₄N₆O₈Cu)); (c) biomolecular ligands including, for example, CD-MOFs; (d) others including, for example, PCN-14 (C₂₇₀H₁₆₂Cu₁₈O₉₀); (e) metal-organic frameworks (MOFs) derivatives that include metal-organic frameworks (MOFs) on the surface of graphene, reduced graphite oxide, carbon nanotubes, MoS₂, activated carbon, and/or the like; and/or (f) metal-organic frameworks (MOFs) derived carbon materials and/or porous metal oxide/carbon composites.

Example covalent-organic frameworks (COFs) have surface areas greater than or equal to about 1,000 m²/g, and in certain aspects, optionally greater than about 2,000 m²/g, and may include (a) boron-containing covalent-organic frameworks (COFs) constructed for example using boronated esters or boronated anhydrides (including, for example, COF-1, COF-103, and/or HHTP-DPB COF); (b) imine-type covalent-organic frameworks (COFs) obtained by condensing polyaldehydes and polyamines (including, for example, COF-300, COF-LZU1, COF-320, BF-COF-1, BF-COF-2, and/or LZU-301); (c) hydrazone-based covalent-organic frameworks (COFs) formed by co-condensation of aldehydes and hydrazides in the presence of acetic acid as a catalyst (including, for example, COF-42, COF-43, COF-JLU4, TFTP-COF, and/or LZU-21); (d) azine-based covalent-organic frameworks (COFs) formed by condensation reaction between polyaldehydes and hydrazine (including, for example, Py-Azine COF, HEX-COF-1, and/or ACOF); (e) imide-based covalent-organic frameworks (COFs) formed by condensation of an amine with acetic anhydride at high temperature (e.g., up to 250° C.) (including, for example, PI-COF-1, PI-COF-2, COF-77, and/or COF-78); (f) ketoenamine-based covalent-organic frameworks (COFs) prepared by irreversible enol-keto tautomerization of ketenimine linkages in imine-based covalent-organic frameworks (COFs) (including, for example, TFP-TPP CH2OF, TFP-TPA COF, TFP-Car COF, and/or β-ketoenamine-linked COFs); (g) sp²-hybridized-carbon-conjugated covalent-organic frameworks (COFs) formed by the Knoevenagel condensations of benzyl cyanides and aldehydes in the presence of the base catalyst (including, for example, sp²c-COF, sp²c-COF-2, and/or sp²c-COF-3); (h) other linkage including, for example, COF-202, polyarylether-based COFs (PAE-COFs), triazine-based COFS (e.g., CTFs); (i) dual linkages including, for example, HHTP-FPBA-TATTA COF; (j) covalent-organic frameworks (COFs) derivatives that include covalent-organic frameworks (COFs) on the surface of graphene, reduced graphite oxide, carbon nanotubes, MoS₂, activated carbon, and/or the like; and/or (k) covalent-organic frameworks (COFs) derived carbon materials.

The positive electrode 24 is formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles. Such positive electroactive material particles may be disposed in one or more layers so as to define the three-dimensional structure of the positive electrode 24. The electrolyte 30 may be introduced, for example after cell assembly, and contained within pores of the positive electrode 24. In certain variations, the positive electrode 24 may include a plurality of solid-state electrolyte particles. In each instance, the positive electrode 24 may have an average thickness greater than or equal to about 1 μm to less than or equal to about 1,000 μm, and in certain aspects, optionally greater than or equal to about 10 μm to less than or equal to about 200 μm.

In various aspects, the positive electroactive material includes a high-voltage oxides, such as LiNi_{0.5}Mn_{1.5}O₄. In other variations, the positive electroactive material includes a layered oxide represented by LiMeO₂, where Me is a transition metal, such as cobalt (Co), nickel (Ni), manganese (Mn), iron (Fe), aluminum (Al), vanadium (V), or combinations thereof. For example, in certain variations, the positive electroactive material may include LiNiₓMn_{y}CO_{1-x-y}O₂ (where 0<x<1 and 0<y<1), LiNiₓCO_{y}Al_{1-x-y}O₂ (where 0<x<1 and 0<y<1), LiNiₓMn₁₋ₓO₂ (where 0<x<1 and 0<y<1), and/or Li₁₊ₓMO₂ (where 0<x<1. In other variations, the positive electroactive material includes an olivine-type oxide represented by LiMePO₄, where Me is a transition metal, such as cobalt (Co), nickel (Ni), manganese (Mn), iron (Fe), aluminum (Al), vanadium (V), or combinations thereof. In still other variations, the positive electroactive material includes a monoclinic-type oxide represented by Li₃Me₂(PO₄)₃, where Me is a transition metal, such as cobalt (Co), nickel (Ni), manganese (Mn), iron (Fe), aluminum (Al), vanadium (V), or combinations thereof. In still other variations, the positive electroactive material includes a spinel-type oxide represented by LiMe₂O₄, where Me is a transition metal, such as cobalt (Co), nickel (Ni), manganese (Mn), iron (Fe), aluminum (Al), vanadium (V), or combinations thereof. In still other variations, the positive electroactive material includes a tavorite represented by LiMeSO₄F and/or LiMePO₄F, where Me is a transition metal, such as cobalt (Co), nickel (Ni), manganese (Mn), iron (Fe), aluminum (Al), vanadium (V), or combinations thereof. In still further variations, the positive electroactive material includes a combination of positive electroactive materials. For example, the positive electrode 24 may include one or more high-voltage oxides, one or more layered oxides, one or more olivine-type oxides, one or more monoclinic-type oxides, one or more spinel-type oxide, one or more tavorite, or combinations thereof. In each instance, the positive electroactive material may be surface coated and/or doped (e.g., LiNbO₃-coated LiNi_{0.5}Mn_{1.5}O₄).

In each variation, the positive electroactive material may be optionally intermingled with an electronically conductive material (i.e. conductive additive) that provide an electron conductive path and/or a polymeric binder material that improve the structural integrity of the positive electrode 24. For example, the positive electrode 24 may include greater than or equal to about 0 wt. % to less than or equal to about 99.5 wt. %, and in certain aspects, optionally greater than or equal to about 60 wt. % to less than or equal to about 95 wt. %, of the positive electroactive material; greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, optionally greater than or equal to about 0.01 wt. % to less than or equal to about 20 wt. %, and in certain aspects, optionally greater than or equal to about 0.01 wt. % to less than or equal to about 5 wt. %, of the polymeric binder. The conductive additive and/or binder material as included in the positive electrode 24 may be the same as or different from the conductive additive and/or binder material as included in the negative electrode 22.

In certain variations, for example, when the positive electrode 24 includes polytetrafluoroethylene (PTFE) and/or polytetrafluoroethylene-based binders, the positive electrode 24 may optionally include porous crystalline material additives, such as metal-organic frameworks (MOFs) and/or covalent-organic frameworks (COFs), each having ordered 1D to 3D pore structures, resulting in ultra-high specific surface areas (e.g., up to 10,500 m²/g). For example, the positive electrode 24 may include greater than or equal to about 0 wt. % to less than or equal to about 20 wt. %, optionally greater than or equal to about 0.01 wt. % to less than or equal to about 20 wt. %, and in certain aspects, optionally greater than or equal to about 0.01 wt. % to less than or equal to about 5 wt. %, of the porous crystalline material additive, and a ratio of the porous crystalline material additive to the polytetrafluoroethylene (PTFE)-based binder may be greater than or equal to about 0.5 to less than or equal to about 2, and in certain aspects, optionally greater than or equal to about 0.6 to less than or equal to about 1. The metal-organic frameworks (MOFs) and/or covalent-organic frameworks (COFs) as included in the positive electrode 24 may be the same as or different from the metal-organic frameworks (MOFs) and/or covalent-organic frameworks (COFs) as included in the negative electrode 22, and as in the negative electrode 22, the porous crystalline material additives (i.e., the metal-organic frameworks (MOFs) and/or covalent-organic frameworks (COFs)) may enhance fibrillation within the positive electrode 24, so as to improve the mechanical strength, and enhance the wettability between the polytetrafluoroethylene (PTFE) and electrolytes. For example, the high specific area of the metal-organic frameworks (MOFs) and/or covalent-organic frameworks (COFs) can be used to provide more anchoring sites for the fibrillation of polytetrafluoroethylene (PTFE), while the nano-size tunable pores of the metal-organic frameworks (MOFs) and/or covalent-organic frameworks (COFs) standing near the polytetrafluoroethylene (PTFE) fibrils are capable of storing more liquid electrolyte (e.g., electrolyte 30).

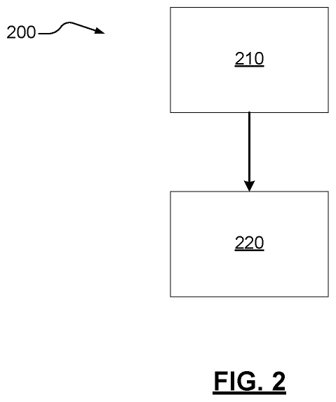

In various aspects, the present disclosure provides methods for preparing electrodes, like the negative and/or positive electrodes 22, 24 illustrated in FIG. 1. For example, in certain variations, as illustrated in FIG. 2, a method 200 for preparing an example electrode may include contacting 210 one or more electrode materials including, for example, the electroactive material together with the conductive additive and/or the binder material and/or the porous crystalline material additive, to form an electrode material mixture. In certain variations, the contacting 210 may include dry mixing the electrode materials at a temperature that is less than about 19° C. The low temperature mixing helps to avoid fibrillation during the contacting 210. Following the contacting 210, the method further includes calendaring 220 the electrode material mixture using, for example, a roll-to-roll process. In certain variations, the calendaring 220 may be a room temperature. In other variations, the calendaring 220 may be a hot roller process. In each instance, the fibrillation occurs primarily during the calendaring 220 process.

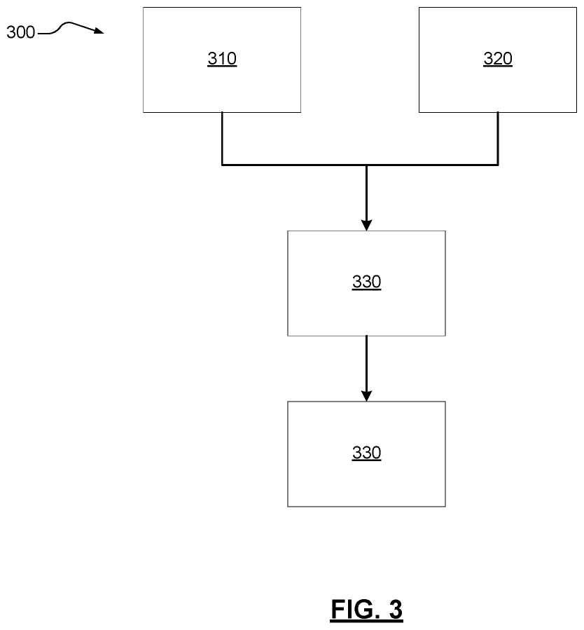

In other variations, as illustrated in FIG. 3, a method 300 for preparing an example electrode may include contacting 310 one or more first electrode materials including, for example, the electroactive material and the conductive additive, to form a first mixture, and contacting 320 one or more second electrode materials including, for example, the binder material and the porous crystalline material additive, to form a second mixture. In certain variations, the contacting 310 may include dry mixing the first electrode materials. In certain variations, the contacting 320 may include dry mixing the electrode materials at a temperature that is less than about 19° C. The low temperature mixing helps to avoid fibrillation during the contacting 310. The contacting 310 of one or more first electrode materials and the contacting 320 of the one or more second electrode materials may occur concurrently or consecutively. Following the contacting 310, 320, the method 300 may further include contacting 330 the first and second mixtures to form an electrode material mixture. The contacting 330 may include dry mixing the electrode materials at a temperature that is less than about 19° C. The low temperature mixing helps to avoid fibrillation during the contacting 330. Following the contacting 330, the method further includes calendaring 340 the electrode material mixture using, for example, a roll-to-roll process. In certain variations, the calendaring 340 may be a room temperature. In other variations, the calendaring 340 may be a hot roller process. In each instance, the fibrillation occurs primarily during the calendaring 340 process.

Certain features of the current technology are further illustrated in the following non-limiting examples.

### Example 1

Example batteries and battery cells may be prepared in accordance with various aspects of the present disclosure.

For example, an example cell 410 may include a positive electrode that includes one or more porous crystalline material additives. For example, the positive electrode may include, for example, polytetrafluoroethylene (PTFE) and ZIF-67 (C₈H₁₀N₄Co). The positive electrode may also include vapor growth carbon fibers (VGCF) and SuperP (SP) as conductive additives. The positive electroactive material may be NM7525. A ratio of the NM7525:SuperP:VGCF:PTFE:ZIF-67 may be 91:3:1:3:2. The negative electrode may include a lithium metal film. A comparative cell 420 may similarly include a lithium metal anode and a positive electrode comprising polytetrafluoroethylene (PTFE), vapor growth carbon fibers (VGCF), SuperP (SP) and NM7525. In the instance of the comparative cell 420, however, the positive electrode excludes the one or more porous crystalline material additives.

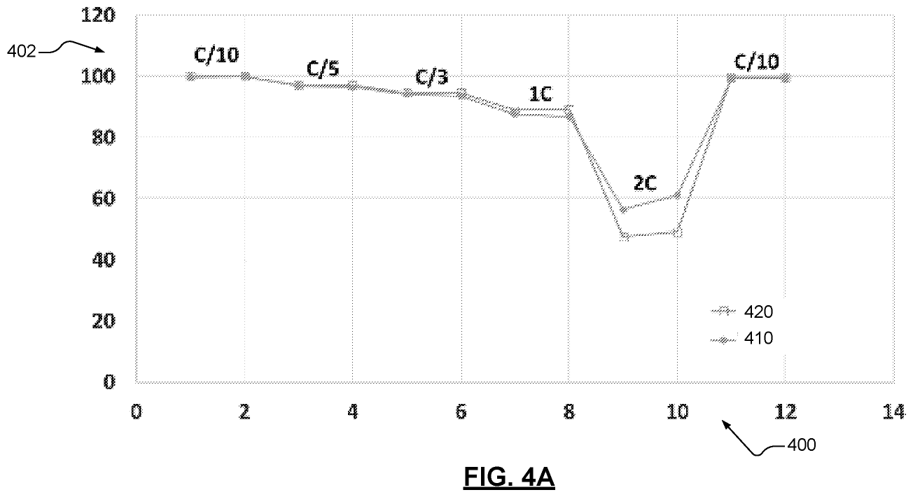

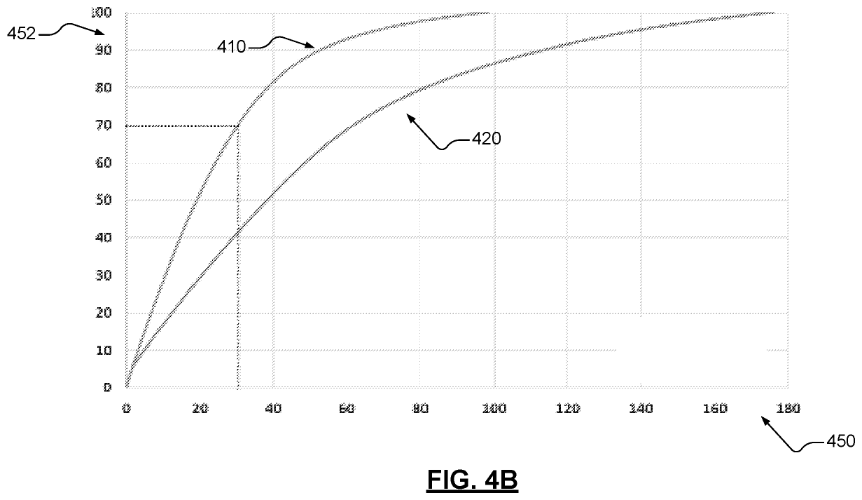

FIG. 4A is a graphical illustrating demonstrating the discharge rate of the example cell 410 as compared to the comparative cell 420, where the x-axis 400 represents cycle number, and the y-axis 402 represents discharge capacity ratio vs C/10(%). As illustrated, example cell 410 has an improved discharge rate.

FIG. 4B is a graphical illustration demonstrating the 2C charge of the example cell 410 as compared to the comparative cell 420, where the x-axis 450 represents time (minutes), and the y-axis 452 represents state of charge (%). As illustrated, example cell 410 has an improved fast-charge capability as compared to the comparative cell 420. For example, up to 70% state of charge can be achieved within 30 minutes for the example cell 410, even with lithium metal foil and a capacity loading higher than 5.0 mAh/cm², while the value is only about 43% for the comparative cell 420.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrode for use in an electrochemical cell that cycles lithium ions, the electrode comprising:
an electroactive material;
a polytetrafluoroethylene-based binder; and
a porous crystalline material additive selected from the group consisting of: metal-organic frameworks (MOFs), covalent-organic frameworks (COFs), and combinations thereof.

2. The electrode of claim 1, wherein the electrode comprises greater than or equal to about 0.01 wt. % to less than or equal to about 20 wt. % of the porous crystalline material additive.

3. The electrode of claim 1, wherein the metal-organic frameworks (MOFs) have a surface area greater than or equal to about 1,000 m²/g and are selected from the group consisting of: IRMOF-16 (Zn₄O(TPDC)₃), IRMOF-1 (Zn₄O(BDC)₃), IRMOF-2 (Zn₄O(BDC-NH₂)₃), IRMOF-8, IRMOF-10, IRMOF-12, IRMOF-14, IRMOF-15, MOF-177 (C₅₄H₁₅O₁₃Zn₄), MOF-188, MOF-200 (Zn₄O(BBC)₂), IRMOF-74-I (Mg₂(DOT)), IRMOF-74-II (Mg2(DH2PHDC)), IRMOF-74-III (Mg₂(DH3PhDC)), HKUST-1 ([Cu₃(C₉H₃O₆)₂]ₙ), MIL-53 (Fe(OH(BDC)), MIL-100 (Fe₃F(H₂O)₂O[(C₆H₃)—(CO₂)₃]₂·nH₂O (where 1<n<10)), MIL-101 ([Cr₃OX (bdc)₃(H₂O)₂] (where bdc is benzene-1,4,dicarboxylate and X is OH or F), UIO-66 (Zr₂₄O₁₂₀C₁₉₂H₉₆N₂₄), UIO-67 (Zr₆O₄(OH)₄⁻·(bpdc) (where bpdc is biphenyldicarboxylate (O₂C(C₆H₄)₂CO₂)), UIO-68 (Zr₆O₄(OH)₄(C₂₀H₁₀O₆)₆(C₃H₇NO)(CH₂Cl₂)₃), ZIF-2, ZIF-3, ZIF-4, ZIR-6, ZIF-5 (Zn₃In₂(Im)₁₂), ZIF-11, ZIR-7, ZIR-8 (C₈H₁₀N₄Zn), ZIF-9 (C₇H₆N₂·Co·H₂O), ZIF-11 (Zn[C₇H₅N₂]₂), ZIF-14 (Zn(elm)₂), ZIF-67 (C₈H₁₀N₄Co), ZIF-68 (C_{7.06}H_{4.94}N_{3.53}O_{1.59}Zn_{0.71}), ZIF-90 (C₄₈H₃₆N₂₄O₁₂Zn₆)), CPL-1 ([Cu₂(pzdc)₂(L)]ₙ) (where 1<n<100)), CPL-2 (C₂₂H₁₂N₆O₈Cu₂), CPL-5 (C₂₄H₁₄N₆O₈Cu), and CD-MOFs, PCN-14 (C₂₇₀H₁₆₂Cu₁₈O₉₀), and combinations thereof.

4. The electrode of claim 1, wherein the covalent-organic frameworks (COFs) have a surface area greater than or equal to about 1,000 m²/g and are selected from the group consisting of: COF-1, COF-103, HHTP-DPB COF, COF-300, COF-LZU1, COF-320, BF-COF-1, BF-COF-2, LZU-301, COF-42, COF-43, COF-JLU4, TFTP-COF, LZU-21, Py-Azine COF, HEX-COF-1, ACOF, PI-COF-1, PI-COF-2, COF-77, COF-78, TFP-TPP CH2OF, TFP-TPA COF, TFP-Car COF, β-ketoenamine-linked COFs, sp²c-COF, sp²c-COF-2, sp²c-COF-3, COF-202, polyarylether-based COFs (PAE-COFs), triazine-based COFS, HHTP-FPBA-TATTA COF, and combinations thereof.

5. The electrode of claim 1, wherein the electrode comprises greater than or equal to about 0.01 wt. % to less than or equal to about 20 wt. % of the polytetrafluoroethylene-based binder.

6. The electrode of claim 1, wherein the polytetrafluoroethylene-based binder comprises:
greater than or equal to about 50 wt. % to less than or equal to about 100 wt. % of polytetrafluoroethylene (PTFE); and
greater than 0 wt. % to less than or equal to about 50 wt. % of an additional binder.

7. The electrode of claim 6, wherein the additional binder is selected from the group consisting of: sodium carboxymethyl cellulose (CMC), polyvinylidene difluoride (PVdF), polyethylene oxide (PEO), polyethylene (PE), polypropylene (PP), and combinations thereof.

8. The electrode of claim 1, wherein the electrode further comprises greater than 0 wt. % to less than or equal to about 30 wt. % of an electrically conductive material.

9. The electrode of claim 1, wherein the electrode has an average thickness greater than or equal to about 50 micrometers to less than or equal to about 500 micrometers.

10. An electrochemical cell that cycles lithium ions, the electrochemical cell comprising:
a first electrode comprising a first electroactive material, a polytetrafluoroethylene-based binder, and a porous crystalline material additive selected from the group consisting of: metal-organic frameworks (MOFs), covalent-organic frameworks (COFs), and combinations thereof;
a second electrode comprising a second electroactive material; and
a separating layer disposed between the first electrode and the second electrode.

11. The electrochemical cell of claim 10, wherein the first electrode comprises greater than or equal to about 0.01 wt. % to less than or equal to about 20 wt. % of the porous crystalline material additive; and greater than or equal to about 0.01 wt. % to less than or equal to about 20 wt. % of the polytetrafluoroethylene-based binder.

12. The electrochemical cell of claim 11, wherein the polytetrafluoroethylene-based binder comprises:
greater than or equal to about 50 wt. % to less than or equal to about 100 wt. % of polytetrafluoroethylene (PTFE); and
greater than 0 wt. % to less than or equal to about 50 wt. % of an additional binder selected from the group consisting of: sodium carboxymethyl cellulose (CMC), polyvinylidene difluoride (PVdF), polyethylene oxide (PEO), polyethylene (PE), polypropylene (PP), and combinations thereof.

13. The electrochemical cell of claim 10, wherein the metal-organic frameworks (MOFs) have a surface area greater than or equal to about 1,000 m²/g and are selected from the group consisting of: IRMOF-16 (Zn₄O(TPDC)₃), IRMOF-1 (Zn₄O(BDC)₃), IRMOF-2 (Zn₄O(BDC-NH₂)₃), IRMOF-8, IRMOF-10, IRMOF-12, IRMOF-14, IRMOF-15, MOF-177 (C₅₄H₁₅O₁₃Zn₄), MOF-188, MOF-200 (Zn₄O(BBC)₂), IRMOF-74-I (Mg₂(DOT)), IRMOF-74-II (Mg2(DH2PHDC)), IRMOF-74-III (Mg₂(DH3PhDC)), HKUST-1 ([Cu₃(C₉H₃O₆)₂]ₙ), MIL-53 (Fe(OH(BDC)), MIL-100 (Fe₃F(H₂O)₂O[(C₆H₃)—(CO₂)₃]₂·nH₂O (where 1<n<10)), MIL-101 ([Cr₃OX (bdc)₃(H₂O)₂] (where bdc is benzene-1,4,dicarboxylate and X is OH or F), UIO-66 (Zr₂₄O₁₂₀C₁₉₂H₉₆N₂₄), UIO-67 (Zr₆O₄(OH)₄⁻·(bpdc) (where bpdc is biphenyldicarboxylate (O₂C(C₆H₄)₂CO₂)), UIO-68 (Zr₆O₄(OH)₄(C₂₀H₁₀O₆)₆(C₃H₇NO)(CH₂Cl₂)₃), ZIF-2, ZIF-3, ZIF-4, ZIR-6, ZIF-5 (Zn₃In₂(Im)₁₂), ZIF-11, ZIR-7, ZIR-8 (C₈H₁₀N₄Zn), ZIF-9 (C₇H₆N₂·Co·H₂O), ZIF-11 (Zn[C₇H₅N₂]₂), ZIF-14 (Zn(elm)₂), ZIF-67 (C₈H₁₀N₄Co), ZIF-68 (C_{7.06}H_{4.94}N_{3.53}O_{1.59}Zn_{0.71}), ZIF-90 (C₄₈H₃₆N₂₄O₁₂Zn₆)), CPL-1 ([Cu₂(pzdc)₂(L)]ₙ) (where 1<n<100)), CPL-2 (C₂₂H₁₂N₆O₈Cu₂), CPL-5 (C₂₄H₁₄N₆O₈Cu), and CD-MOFs, PCN-14 (C₂₇₀H₁₆₂Cu₁₈O₉₀), and combinations thereof; and
the covalent-organic frameworks (COFs) have a surface area greater than or equal to about 1,000 m²/g and are selected from the group consisting of: COF-1, COF-103, HHTP-DPB COF, COF-300, COF-LZU1, COF-320, BF-COF-1, BF-COF-2, LZU-301, COF-42, COF-43, COF-JLU4, TFTP-COF, LZU-21, Py-Azine COF, HEX-COF-1, ACOF, PI-COF-1, PI-COF-2, COF-77, COF-78, TFP-TPP CH2OF, TFP-TPA COF, TFP-Car COF, β-ketoenamine-linked COFs, sp²c-COF, sp²c-COF-2, sp²c-COF-3, COF-202, polyarylether-based COFs (PAE-COFs), triazine-based COFS, HHTP-FPBA-TATTA COF, and combinations thereof.

14. The electrochemical cell of claim 10, wherein the electrode further comprises greater than 0 wt. % to less than or equal to about 30 wt. % of an electrically conductive material.

15. The electrochemical cell of claim 10, wherein the electrode has an average thickness greater than or equal to about 50 micrometers to less than or equal to about 500 micrometers.

16. The electrochemical cell of claim 10, wherein the polytetrafluoroethylene-based binder is a first polytetrafluoroethylene-based binder, the porous crystalline material additive is a first porous crystalline material additive, and the second electrode further comprises a second polytetrafluoroethylene-based binder and a second porous crystalline material additive selected from the group consisting of: metal-organic frameworks (MOFs), covalent-organic frameworks (COFs), and combinations thereof, the second polytetrafluoroethylene-based binder being the same as or different from the first polytetrafluoroethylene-based binder, and the second porous crystalline material additive being the same as or different from the first porous crystalline material additive.

17. The electrochemical cell of claim 10, wherein the second electrode comprises greater than or equal to about 0.01 wt. % to less than or equal to about 20 wt. % of the porous crystalline material additive; and greater than or equal to about 0.01 wt. % to less than or equal to about 20 wt. % of the polytetrafluoroethylene-based binder.

18. An electrochemical cell that cycles lithium ions, the electrochemical cell comprising:
a first electrode having a first average thickness greater than or equal to about 50 micrometers to less than or equal to about 500 micrometers and comprising:
greater than 0 wt. % to less than or equal to about 99.5 wt. % of a first electroactive material;
greater than 0.01 wt. % to less than or equal to about 20 wt. % of a first polytetrafluoroethylene-based binder; and
greater than 0.01 wt. % to less than or equal to about 20 wt. % of a first porous crystalline material additive;
a second electrode having a second average thickness greater than or equal to about 50 micrometers to less than or equal to about 500 micrometers and comprising:
greater than 0 wt. % to less than or equal to about 99.5 wt. % of a second electroactive material;
greater than 0.01 wt. % to less than or equal to about 20 wt. % of a second polytetrafluoroethylene-based binder; and
greater than 0.01 wt. % to less than or equal to about 20 wt. % of a second porous crystalline material additive, the first and second crystalline material additives being independently selected from the group consisting of: metal-organic frameworks (MOFs), covalent-organic frameworks (COFs), and combinations thereof; and
a separating layer disposed between the first electrode and the second electrode.

19. The electrochemical cell of claim 18, wherein at least one of the first electrode and the second electrode further comprises greater than 0 wt. % to less than or equal to about 30 wt. % of an electrically conductive material.

20. The electrochemical cell of claim 18, wherein the metal-organic frameworks (MOFs) have a surface area greater than or equal to about 1,000 m²/g and are selected from the group consisting of: IRMOF-16 (Zn₄O(TPDC)₃), IRMOF-1 (Zn₄O(BDC)₃), IRMOF-2 (Zn₄O(BDC-NH₂)₃), IRMOF-8, IRMOF-10, IRMOF-12, IRMOF-14, IRMOF-15, MOF-177 (C₅₄H₁₅O₁₃Zn₄), MOF-188, MOF-200 (Zn₄O(BBC)₂), IRMOF-74-I (Mg₂(DOT)), IRMOF-74-II (Mg2(DH2PHDC)), IRMOF-74-III (Mg₂(DH3PhDC)), HKUST-1 ([Cu₃(C₉H₃O₆)₂]ₙ), MIL-53 (Fe(OH(BDC)), MIL-100 (Fe₃F(H₂O)₂O[(C₆H₃)—(CO₂)₃]₂·nH₂O (where 1<n<10)), MIL-101 ([Cr₃OX (bdc)₃(H₂O)₂] (where bdc is benzene-1,4,dicarboxylate and X is OH or F), UIO-66 (Zr₂₄O₁₂₀C₁₉₂H₉₆N₂₄), UIO-67 (Zr₆O₄(OH)₄⁻·(bpdc) (where bpdc is biphenyldicarboxylate (O₂C(C₆H₄)₂CO₂)), UIO-68 (Zr₆O₄(OH)₄(C₂₀H₁₀O₆)₆(C₃H₇NO)(CH₂Cl₂)₃), ZIF-2, ZIF-3, ZIF-4, ZIR-6, ZIF-5 (Zn₃In₂(Im)₁₂), ZIF-11, ZIR-7, ZIR-8 (C₈H₁₀N₄Zn), ZIF-9 (C₇H₆N₂·Co·H₂O), ZIF-11 (Zn[C₇H₅N₂]₂), ZIF-14 (Zn(elm)₂), ZIF-67 (C₈H₁₀N₄Co), ZIF-68 (C_{7.06}H_{4.94}N_{3.53}O_{1.59}Zn_{0.71}), ZIF-90 (C₄₈H₃₆N₂₄O₁₂Zn₆)), CPL-1 ([Cu₂(pzdc)₂(L)]ₙ) (where 1<n<100)), CPL-2 (C₂₂H₁₂N₆O₈Cu₂), CPL-5 (C₂₄H₁₄N₆O₈Cu), and CD-MOFs, PCN-14 (C₂₇₀H₁₆₂Cu₁₈O₉₀), and combinations thereof; and
the covalent-organic frameworks (COFs) have a surface area greater than or equal to about 1,000 m²/g and are selected from the group consisting of: COF-1, COF-103, HHTP-DPB COF, COF-300, COF-LZU1, COF-320, BF-COF-1, BF-COF-2, LZU-301, COF-42, COF-43, COF-JLU4, TFTP-COF, LZU-21, Py-Azine COF, HEX-COF-1, ACOF, PI-COF-1, PI-COF-2, COF-77, COF-78, TFP-TPP CH2OF, TFP-TPA COF, TFP-Car COF, β-ketoenamine-linked COFs, sp²c-COF, sp²c-COF-2, sp²c-COF-3, COF-202, polyarylether-based COFs (PAE-COFs), triazine-based COFS, HHTP-FPBA-TATTA COF, and combinations thereof.
